(19) United States
(12) Patent Application Publication
(10) Pub. No.: US 2007/0143849 A1
(43) Pub. Date: Jun. 21, 2007

(54) Method and a software system for end-to-end security assessment for security and CIP professionals

(76) Inventor: Eyal Adar, Tel Aviv (IL)

Correspondence Address: Angenehm Law Firm, Ltd., P.O. Box 48755, Coon Rapids, MN, 55448-0755, US

(21) Appl. No.: 11/305,196

(22) Filed: Dec. 19, 2005

(51) Int. Cl. G06F 11/00

(52) U.S. Cl. 726/25

(57) ABSTRACT

A method and software system for Security and CIP Professionals (CIP) that addresses the shortcomings in today's Critical Infrastructure Protection (CIP) methods, and offers a new security assessment methodology equipped to meet the present challenges of CIP, as well as future challenges. The method is based on an End-to-End Security Assessment (EESA) that provides a wide examination of system information flows. The method disclosed is for implementing end-to-end security assessment (EESA) for use by Security and CIP professionals for large, complex, critical infrastructure (LCCI) systems. The first step of the method is determining security policy and sensitivity levels of data. Further steps include identifying and analyzing critical business-derived information flows for the layers, security mechanisms, formats and communications protocols of the system; assessing each of said information flows for security gaps; determining the risk level of each of said information flows by applying a formula that takes into account the threat, its likelihood and its potential impact on the system; comparing the required defence levels to said security mechanisms, listing all gaps found according to a prioritization process that determines the urgency of closing each gap and creating a detailed list of the prioritized gaps; and offering specific countermeasures to close each of said gaps, wherein emphasis is put on optimizing said countermeasures.

### FIELD OF THE INVENTION

The present invention relates to methods and software for security assessment and Risk Management. More particularly, the present invention relates to a method and a software system for end-to-end security assessment for Security and CIP (Critical Infrustructure Protection) professionals for large, complex, critical infrastructure (LCCI) systems.

### BACKGROUND OF THE INVENTION

The ACIP project is a European Union initiative directed at providing the European R&D roadmap for Analysis and Assessment of Critical Infrastructure Protection (ACIP). ACIP focuses on research designed to identify and develop tools, methodologies and technologies for the protection of critical infrastructures. One of the major concerns of the ACIP project, according to Gwendal Legrand in Roadmap For Provision Of Methodologies For CIS Investigations, was the fact that critical infrastructures are becoming targets of increasing physical and cyber attacks. This begged the question whether the available methods of coping with these attacks are adequate for the enormous task of protecting huge complex networked systems. Perhaps not surprisingly, the answer was that current methods have major gaps that need to be dealt with in order to achieve an adequate level of security, i.e., where critical systems can continue to function, even when under attack.

The ACIP project investigated all current methods and offered the road map for new methods. One of the interesting findings was the fact that even the task of assessing a critical system's security level, an essential initial task in any attempt to secure a system, cannot be easily done with available methods.

The scope of assessing a security level of operational systems, for example, a nation-wide electronic network, was not taken into account when current methods were planned. No method is capable of assessing hundreds or thousands of servers, various local and wide area networks, as well as standard and proprietary or home-grown systems, etc. The ACIP project determined that the software tools already in place may help in such a case, but their major drawback is that they address specific information technology (IT) platforms, and lack an ‘overall’ security assessment capability. When addressing a complex system with existing tools it is easy to lose sight of the larger picture. Instead of a clear vision of a complex critical system's security level one may end up in deeper confusion.

Platform-specific tools are readily available, but unfortunately they can help only if the larger picture becomes clear. There are also several available high-level methods that are not applicable in most CIP instances. Most high level methods detach themselves from actual technical details in an attempt to remain the same even when technologies have changed. Perhaps the best proof for their inapplicability is the finding that the critical infrastructure's (CI's) IT operations staff, by and large, are not using high level methods, since the information that the high level systems provide is often too abstract and fails to provide a practical guide for IT professionals.

Thus, there is a need that had clearly arisen from the ACIP investigation is for a method that will connect both ends—the high level and the platform specific—and would produce results that the IT professionals will be able to use. The new methods must be practical and aware of the business issues related to the critical infrastructures.

### SUMMARY OF THE INVENTION

Accordingly, it is a principal object of the present invention to overcome the limitations of the prior art, and provide a method and software system for end-to-end security assessment for Security and CIP professionals.

It is another object of the present invention to provide an improved method that will complement, rather than replace, existing methods.

It is a further object of the present invention to provide an improved method that will provide a centralized security approach to decentralized environments.

A method is disclosed for implementing end-to-end security assessment (EESA) for use by Security and CIP professionals for large, complex, critical infrastructure (LCCI) systems. The first step of the method is determining security policy and sensitivity levels of data. Further steps include identifying and analyzing critical business-derived information flows for the layers, security mechanisms, formats and communications protocols of the system; assessing each of said information flows for security gaps; determining the risk level of each of said information flows by applying a formula that takes into account the threat, its likelihood and its potential impact on the system; comparing the required defence levels to said security mechanisms, listing all gaps found according to a prioritization process that determines the urgency of closing each gap and creating a detailed list of the prioritized gaps; and offering specific countermeasures to close each of said gaps, wherein emphasis is put on optimizing said countermeasures.

In most Critical Infrastructures the IT systems are by definition distributed. The extent of distribution has been growing in the last few years and has several dimensions: geographical; organizational; functional; and technological distribution into sub-systems and outsourcing implications. The distributed nature of the systems also produces a responsibility distribution, and therefore systems are being addressed and maintained as independent parts. As a result, there is a growing tendency for security gaps.

A central point of view to security assessment processes provides the ability to address a system as a whole, and not as a set of different components with different responsibilities. In many cases one can avoid the penalty for performing a security measures, if the desired security level is achieved through other parts of the system. As a result of this need, the new paradigm should make sure that all the relevant aspects and components of the distributed system are taken into consideration in the security assessment. This will be possible by performing a system-wide end-to-end assessment, and by closely examining major information flows.

There is an absence of a practical and ready to use method. This is a further elaboration of the issue of high-level methods and platform-based methods discussed above. Security methodologies often tend to be highly theoretical, while security practices are often highly technical and lack a structured approach. The new method should aim at connecting the two, with a comprehensive bridging approach.

Additional features and advantages of the invention will become apparent from the following drawings and description.

### BRIEF DESCRIPTION OF THE DRAWINGS

For a better understanding of the invention in regard to the embodiments thereof, reference is made to the accompanying drawings and description, in which like numerals designate corresponding elements or sections throughout, and in which:

FIG. 1 is a schematic illustration of bridging the gap between existing methods, according to a preferred embodiment of the present invention;

FIG. 2 is a schematic block diagram of the top-down approach method, according to a preferred embodiment of the present invention;

FIG. 3 is a schematic block diagram of the five phases of EESA, according to one preferred embodiment of the present invention;

FIG. 4 is a schematic illustration of the information flow, according to one preferred embodiment of the present invention;

FIG. 5 is a schematic flow diagram of an exemplary cash transaction, according to one embodiment of the present invention;

FIG. 6 is a schematic illustration of an exemplary access control mechanism, according to one embodiment of the present invention; and

FIG. 7 is a schematic illustration of an exemplary assortment of access control mechanisms involved in a cash transfer, according to one embodiment of the present invention.

### DETAILED DESCRIPTION OF PREFERRED EMBODIMENTS

The invention will now be described in connection with certain preferred embodiments with reference to the following illustrative figures so that it may be more fully understood. References to like numbers indicate like components in all of the figures.

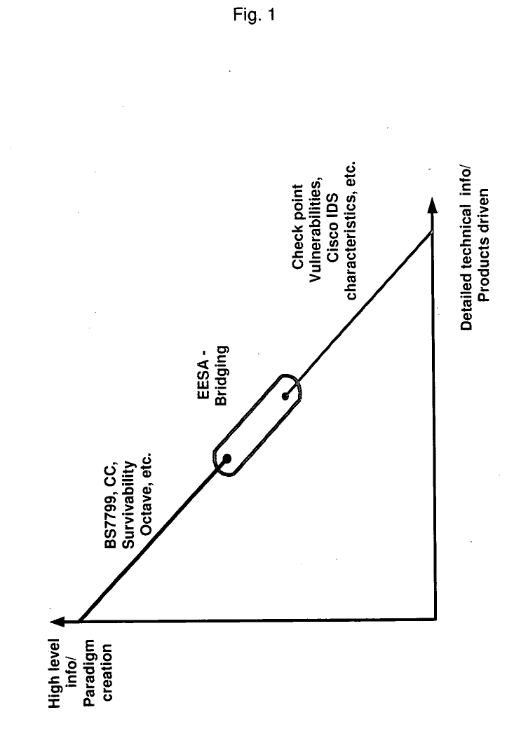

Reference is now made to FIG. 1, which is a schematic illustration of bridging the gap 110 between existing methods 120 and 130, according to a preferred embodiment of the present invention.

Theoretical approaches are often seen in academic research and the work of standard bodies. The approaches are usually high-level and are “built to last”—refraining as much as possible from discussing particular technologies, let alone products. Their main advantage is that they can be adapted to any environment, however their lack of practicality make them difficult to implement.

Technical practices often include vast amounts of information regarding products and solutions. Examples are operating system (OS) vulnerabilities, necessary patches for each OS, known exposures in particular applications and how to prevent them, etc. This knowledge does not amount to a systematic approach to security, and is closely associated with particular environments. It does not help in cases where system interdependencies are involved.

Finally, there is a major flaw in most exiting methods. Even though the methods view the systems as wholes comprised of components, their focus is securing each and every component, rather than the system as a whole.

The new method must attempt to bridge both types of approaches by providing a comprehensive approach. On the one hand it should provide high-level and cross-environmental methodologies and give an answer for differing environments. On the other hand it should go into details and analyze the most fundamental components of the systems, and thereby answer the most practical questions in each project.

Thus by design, the method of the present invention can be used as a complementary method. It is designed to complement accepted methodologies, such as the Common Criteria, Survivability and BS 7799 (120). It preferably concentrates on integrating into existing methodologies and, more specifically, on providing a “ready to use” assessment tool for critical systems.

The most dangerous business related combined internal and external attacks today, that put critical infrastructures at risk, are sophisticated attacks, often perpetrated with the aid of internal employees, that take advantage of the specific characteristics of the system, and that are carried out by highly professional and well funded groups like terrorists or crime organizations that often study and use attack methods that are carried out by governmental organizations.

Most of today's solutions are designed to prevent external attacks only, mostly. Internet attacks, and have generic-not-aware-of-specific-characteristics. The proposed assessment process must perform an end-to-end analysis, covering security mechanisms that protect from external breaches, as well as address internal security mechanisms.

It has recently become clear to countries around the world that protecting critical infrastructures has been neglected in the last few years. The gaps are especially wide because of the major technological advances of recent years in critical infrastructure systems. Many critical systems are especially difficult to protect with older methods and mechanisms, because the systems are more complex and highly distributed than before. In many cases very limited inherent security is found in the systems, even though the need for a high security level is clear. Furthermore, it is impossible to properly analyze critical infrastructures without a deep understanding of the relationship between the physical and the cyber infrastructures. And perhaps the most difficult issue to tackle is the interdependencies among the different systems, which complicates the security issues as well as creates a major risk—the risk of a collapse of not one, but two or more critical systems in case of an attack.

A major issue in this field is the requirement for a better understanding of the specific needs of each CI sector and the specific ways to protect it. The security vendors provide off-the-shelf solutions for security purposes. These products give generic abilities, and are not customized for the specific needs of each sector. While the industry at large may find this satisfactory, CIP managements are starting to understand that there is a need for more adequate solutions. The method of the present invention is inherently designed to analyze the specific business needs and specific information flows in each system and translate them to security requirements. This addresses the critical infrastructure's special security needs. and is suitable both for securing existing critical IT systems and for designing new highly critical and dependable ones.

EESA (End to End Security Assessment) is a security assessment method that was developed especially for distributed critical systems. The method is based on the identification of critical information flows within a system, and an end-to-end analysis of the security services along each information flow.

The method analyzes the “Security Quality of Service” (SQOS) along the critical information flows, and checks whether the security mechanisms are adequate for protecting against probable threats. The method further analyzes the threats that the mechanisms do protect against, the ones that it will not be able to thwart and suggests corrective measures that bring the system up to the required security level.

One of the main principles underlying the method is the analysis of a process that can span many sub-systems. The analysis may begin at an employee's workstation, pass through several servers in several countries, leave the organization and go through a hosted server, return to the organization and end in a transaction at a remote database. The process may pass through several protocols and formats as well, starting as an html page sent via http to a web server, changing to JAVA on its way to an application server, then proceeding to SQL over JDBC to the database, etc. The analysis keeps track of the entire path, and checks each and every station on the way and the gaps created by the changes in every stage of the process. EESA addresses: gaps that can be created by technology changes; organizational distribution and lack of clarity regarding security responsibilities; system distribution and lack of clarity regarding security levels within the different sub-systems; and limitations in the business and the process/environment.

Since the method views the system as a collection of business derived information flows, and systematically analyzes their needs, it can eventually lead to best practices in system design and system architecture design, methods of risk analysis and internal or external security reviews.

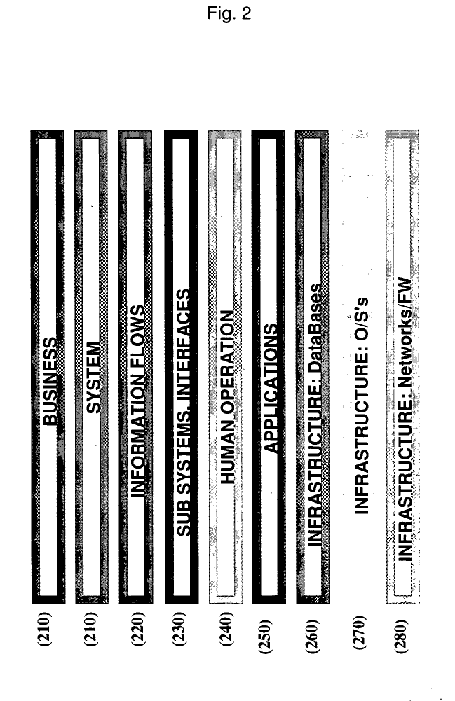

FIG. 2 is a schematic block diagram of the top-down approach method, according to one preferred embodiment of the present invention. This provides better understanding of the risks and better countermeasure recommendations, and thereby leads to a higher level of security in the assessed systems. EESA's strength is in its assessment approach that is based on analyzing the business processes 210 and the information flows 220 derived from them. Along information flows 220, a more detailed look at the sub-systems 230 is performed, going into the human aspects of the activity 240, and drilling down to the application platforms 250 and lower to the infrastructure components such as OS 260, databases 270 and network devices 280. This strategy provides numerous advantages and a better basis for approaching the other phases of security assessment, such as risk analysis and gap analysis, and can be used in various phases of the project lifecycle.

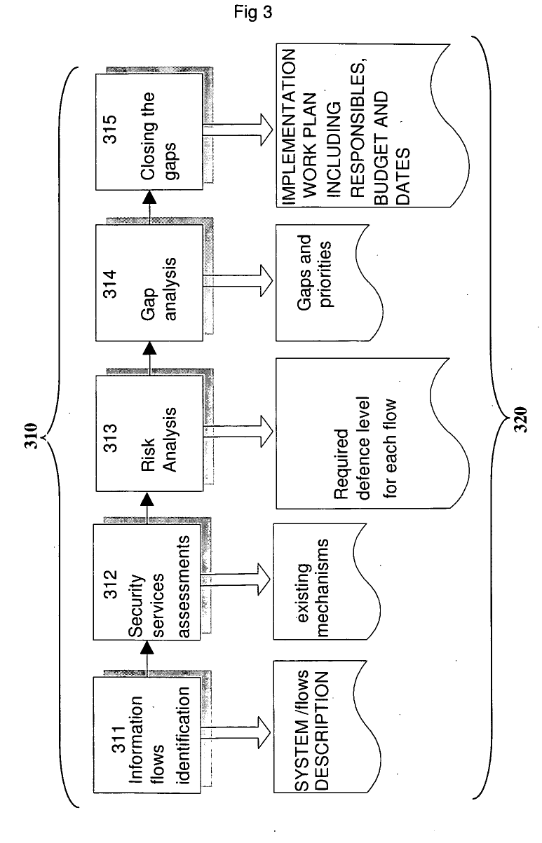

FIG. 3 is a schematic block diagram of the five phases 310 and deliverables 320 of EESA, according to one preferred embodiment of the present invention. The illustration shows deliverables 320—documents, reports and work plans—that are produced at each stage. It is important to note here, that most of phases 310 are not unique to EESA, but are part of known security practices throughout the world. EESA's innovative aspects include a new approach to phases 1 and 2 that analyzes the system. A brief description of the phases is provided below.

Before beginning the analysis, an understanding of the organization's general security requirements must be achieved. This includes, among other things, the sensitivity levels of various data, the security policy and other information.

Phase I—Critical Information Flows Identification 311

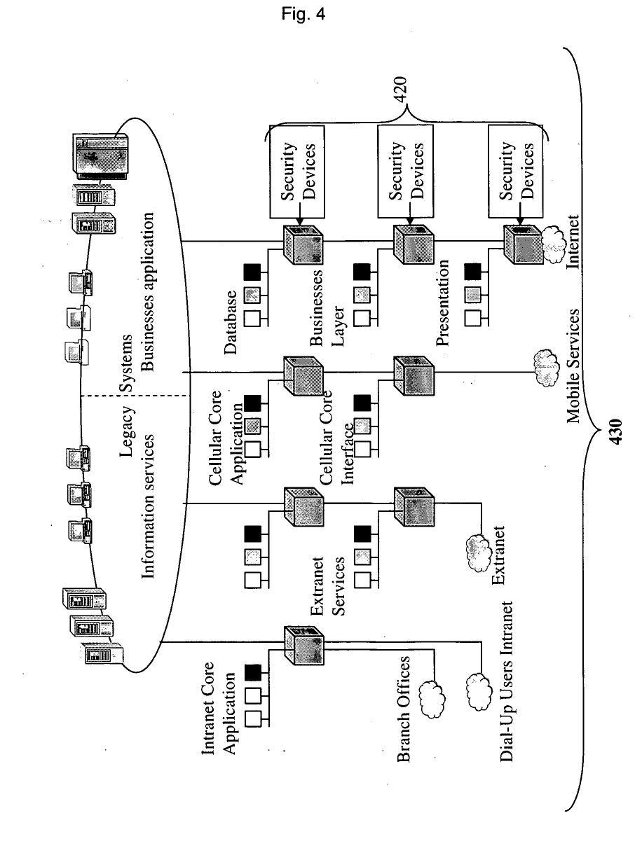

FIG. 4 is a schematic illustration of the information flow, according to one preferred embodiment of the present invention. The first stage in applying EESA involves a deep analysis of the system processes from a business point of view. This is in order to identify and analyze the main information flows in the system. As seen in FIG. 4, an information flow can traverse several layers, several security mechanisms 420 as well as several technologies, including different formats and communication protocols 430.

Phase II—Security Services Assessment 312

At this stage each information flow identified in Phase I, is examined from a security point of view. It is here that many holes that are usually missed by existing methods are found. Assessment of Security mechanisms for each security service, along the information flows. This is done with an end-to-end centralized approach and is the heart of the process.

Assessment of Security mechanisms is done for each security service (Identification, authentication, authorization . . . ). Service is the global security area and a mechanism is a specific way to implement it.

For each service assess the mechanisms along the flow:

Existing mechanisms;

End to end continuity, uncovered areas;

Defense level of each security mechanism; and

End-to-end defense level (Dependencies between different mechanisms for each service); and

Assess the dependencies between different services (especially in case of gaps).

This assessment will allow identification and remediation of vulnerabilities in phase III that could not be traced otherwise. All of the security weaknesses found at this stage are noted, but in most cases recommendations for closing the gaps are only made at Phase V, after the security requirements have been clearly defined.

The security services include:

identification;

authentication;

authorization;

access control;

confidentiality;

non-repudiation;

data-integrity;

auditing, alerts; and

availability.

The security services are implemented that are needed to answer the potential threats throughout an “Information stream.” It is important to cover all the services. Access control, for example, determines whether something is allowed within the system. Non-repudiation means that once an activity has been done, it cannot be denied that it has been done. Confidentiality can be implemented, for example, with a specific encryption of VPN or WinZip™.

For example, authentication can be implemented in different ways for the computer, the router, the first Web server and the database.

Phase III—Risk Analysis 313

Risk analysis 313 that is carried out at this stage determines the risk level in each information flow, and in the system as a whole. The potential threats are derived from potential attack scenarios/attack trees. The likelihood of each impact is also taken into account, and the risk level is determined by a formula that takes into account the threat, its likelihood and its potential impact.

Phase IV—Gap Analysis 314

During the Gap Analysis phase the required defence levels (preliminarily achieved) are compared to the existing security mechanisms. During this phase all of the gaps are listed. A prioritization process that determines the urgency of closing each gap follows. The end result is a detailed list of the prioritized gaps.

Phase V—Closing the Gap—Architecture Design 315

At this stage specific countermeasures are offered to close each of the gaps uncovered at the previous phase. Focus is put on optimizing the recommended solutions. I.e., the different risks are addressed as a whole, and the system is again looked upon as a set of business-derived information flows, so that the countermeasures will ensure the adequacy of the entire system's level of security. A detailed implementation work plan is created at this stage, which includes the technical processes as well as the responsibilities, budget and timetable. An analysis of the residual risk, i.e. the risks that remain after all counter-measures are carried out, completes this phase and the EESA assessment process.

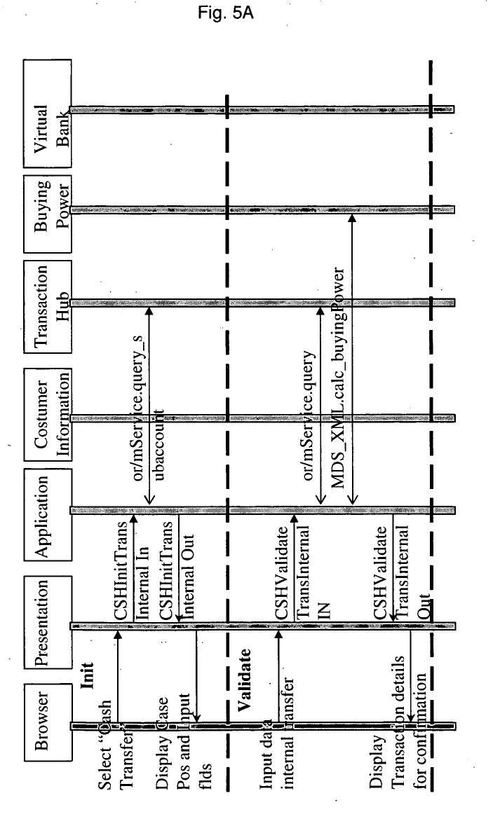

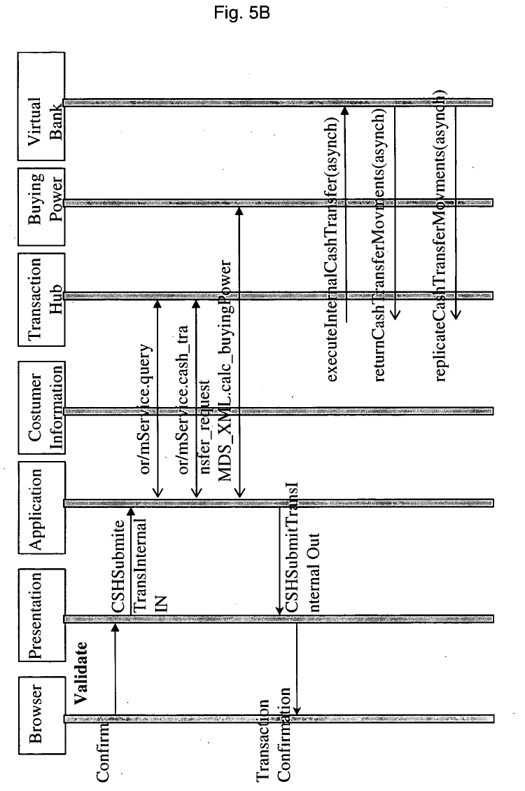

FIG. 5 is a schematic flow diagram of an exemplary cash transaction within a banking system according to one embodiment of the present invention. The three major stages of the transaction are initialize 510, validate 520 and submit 530.

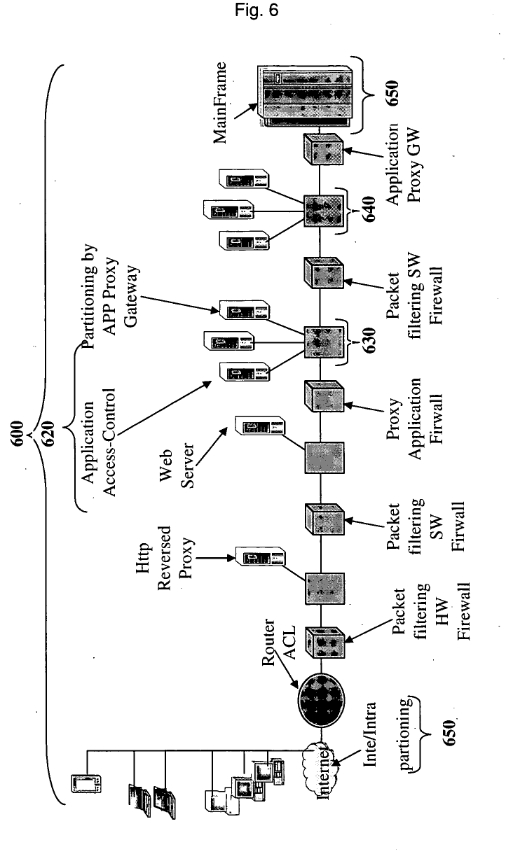

FIG. 6 is a schematic illustration of an exemplary access control mechanism having several application tiers 600, according to one embodiment of the present invention. FIG. 6 illustrates the need for cross-platform and multi-layered Access Control. The application tiers with any respective access control mechanisms include:

a user: a browsers 610;

presentation: portal and Web server 620;

business logic: an application 630;

databases 640; and

mainframes 650.

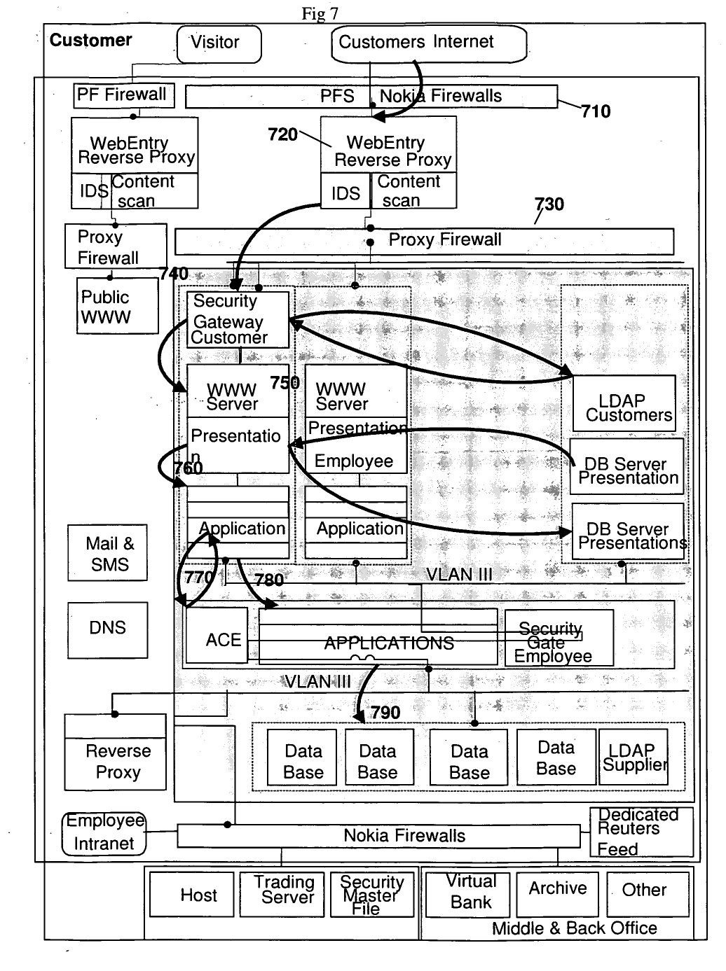

FIG. 7 is a schematic illustration of an exemplary assortment of access control mechanisms involved in a cash transfer 700, according to one embodiment of the present invention:

network partitioning (interne/intranet);

packet filtering firewall 710;

reversed proxy 720;

application firewall 730;

security gateway 740;

web server access control;

OS access control;

application partitioning;

core application access control;

database access control; and

application firewall 730.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

I claim:

1. A method for implementing end-to-end security assessment (EESA) for use by Security and CIP professionals for large, complex, critical infrastructure (LCCI) systems, comprsing:
determining security policy and sensitivity levels of data;
identifying and analyzing critical business-derived information flows for the layers, security mechanisms, formats and communications protocols of the system;
assessing each of said information flows for security gaps;
determining the risk level of each of said information flows by applying a formula that takes into account the threat, its likelihood and its potential impact on the system;
comparing the required defence levels to said security mechanisms, listing all gaps found according to a prioritization process that determines the urgency of closing each gap and creating a detailed list of the prioritized gaps; and
offering specific countermeasures to close each of said gaps, wherein emphasis is put on optimizing said countermeasures.

2. The method according to claim 1, wherein offering specific countermeasures further comprises addressing said risk levels as a whole, so that said countermeasures will ensure the adequacy of the entire system's level of security.

3. The method according to claim 2, further comprising creating a detailed implementation work plan is created, which includes the technical processes as well as the responsibilities, budget and timetable.

4. The method according to claim 3, further comprising analyzing the risks that remain after all of said counter-measures are carried out.

5. A software system according to the method of claim 1, comprising an automated tool for real-time end-to-end security assessment (EESA) for use by Security and CIPsecurity professionals for large, complex, critical infrastructure (LCCI) computer systems.

6. A software system according to the method of claim 5, adapted for use with personal computer systems.

7. A software system according to the method of claim 5, comprising an automated tool for real-time end-to-end security assessment (EESA) for use by Security and CIPsecurity professionals for large, complex, critical infrastructure (LCCI) systems, wherein the automated tool is primarily adapted for monitoring purposes.

8. A software system according to the method of claim 7, further comprising an agent for providing the monitoring.

9. A software system according to the method of claim 8, further comprising a separate agent for each component of the computer system.

10. A software system according to the method of claim 8, wherein each agent collects and sends sends information to a service provider for analysis.
